(19) United States
(12) Patent Application Publication
(10) Pub. No.: US 2025/0192351 A1
(43) Pub. Date: Jun. 12, 2025

(54) BATTERY PACK VENTING ASSEMBLY AND VENTING METHOD

(71) Applicant: Ford Global Technologies, LLC, Dearborn, MI (US)

(72) Inventors: Nathan Lee, Novi, MI (US); Chulheung Bae, Troy, MI (US); Adam Denlinger, Saline, MI (US)

(21) Appl. No.: 18/534,951

(22) Filed: Dec. 11, 2023

(51) Int. Cl. H01M 50/358; H01M 10/613; H01M 10/625; H01M 10/6568; H01M 50/209; H01M 50/325

(52) U.S. Cl. CPC H01M 50/358; H01M 10/613; H01M 10/625; H01M 10/6568; H01M 50/209; H01M 50/325

(57) ABSTRACT

A battery pack venting assembly includes a battery pack enclosure assembly providing an battery pack interior, and cell stacks within the battery pack interior. Each cell stack includes a plurality of battery cells. Module enclosure assemblies are also within the battery pack interior. Each of the module enclosure assemblies houses one or more of the cell stacks. An exhaust trunk extends through the battery pack enclosure assembly from the battery pack interior to an area outside the battery pack interior. Exhaust branches within the battery pack interior each extend from one of the module enclosure assemblies to the exhaust trunk.

### TECHNICAL FIELD

This disclosure relates generally to discharging vent byproducts from a traction battery pack.

### BACKGROUND

Electrified vehicles differ from conventional motor vehicles because electrified vehicles are selectively driven using one or more electric machines powered by a traction battery. The electric machines can drive the electrified vehicles instead of, or in addition to, an internal combustion engine. Example electrified vehicles include hybrid electric vehicles (HEVs), plug-in hybrid electric vehicles (PHEVs), fuel cell vehicles (FCVs), and battery electric vehicles (BEVs).

With reference to FIG. 1, a prior art battery pack 2 includes a plurality of battery cell groupings 4 disposed within an interior of an enclosure 6. If a battery cell in one of the groups 4 is venting, vent byproducts are released into an interior of the enclosure 6. Within the interior of the enclosure 6, the vent byproducts can flow adjacent to other battery cell groupings 4 prior to passing through a vent 8 to an area outside the enclosure 6.

### SUMMARY

In some aspects, the techniques described herein relate to a battery pack venting assembly, including: a battery pack enclosure assembly providing an battery pack interior; a plurality of cell stacks within the battery pack interior, each cell stack including a plurality of battery cells; a plurality of module enclosure assemblies within the battery pack interior, each of the module enclosure assemblies housing one or more of the cell stacks; an exhaust trunk extending through the battery pack enclosure assembly from the battery pack interior to an area outside the battery pack interior; a plurality of exhaust branches within the battery pack interior, each of the exhaust branches extending from one of the module enclosure assemblies to the exhaust trunk.

In some aspects, the techniques described herein relate to a battery pack venting assembly, wherein the exhaust branches each open to the exhaust trunk within the battery pack interior.

In some aspects, the techniques described herein relate to a battery pack venting assembly, wherein the exhaust branches are each configured to communicate vent byproducts directly from one of the module enclosure assemblies to the exhaust trunk.

In some aspects, the techniques described herein relate to a battery pack venting assembly, wherein the exhaust trunk is configured to communicate vent byproducts received from one or more of the exhaust branches to the area outside the battery pack enclosure assembly.

In some aspects, the techniques described herein relate to a battery pack venting assembly, wherein the module enclosure assemblies, the exhaust branches, and the exhaust trunk are sealed such that, within the battery pack interior, vent byproducts are contained by the module enclosure assemblies, the exhaust branches, and the exhaust trunk.

In some aspects, the techniques described herein relate to a battery pack venting assembly, wherein the cell stacks are immersion cooled.

In some aspects, the techniques described herein relate to a battery pack venting assembly, further including a plurality of coolant inlet branches, each of the coolant inlet branches configured to communicate a liquid coolant to one of the module enclosure assemblies.

In some aspects, the techniques described herein relate to a battery pack venting assembly, further including a coolant inlet trunk that communicates a liquid coolant to each of the plurality of coolant inlet branches.

In some aspects, the techniques described herein relate to a battery pack venting assembly, wherein the coolant inlet branches are directly connected to the coolant inlet trunk within the battery pack interior.

In some aspects, the techniques described herein relate to a battery pack venting assembly, wherein the plurality of exhaust branches are configured to communicate liquid coolant and vent byproducts directly from one of the module enclosure assemblies to the exhaust trunk.

In some aspects, the techniques described herein relate to a battery pack venting assembly, wherein the battery cells are each configured to vent into a liquid coolant.

In some aspects, the techniques described herein relate to a battery pack venting assembly, further including a plurality of check valves that block a backflow of vent byproducts from the exhaust trunk through the exhaust branches.

In some aspects, the techniques described herein relate to a method of venting from a battery pack, including: within a battery pack interior provided by a battery pack enclosure assembly, communicating vent byproducts from a battery module enclosure assembly into an exhaust branch, the vent byproducts expelled from at least one battery cell within a cell stack that is housed within the battery pack interior; within the battery pack interior, communicating the vent byproducts through the exhaust branch into an exhaust trunk; and communicating the vent byproducts through the exhaust trunk through the battery pack enclosure to an area outside the battery pack enclosure to exhaust the vent byproducts from the battery pack enclosure.

In some aspects, the techniques described herein relate to a method, wherein the module enclosure assemblies, the exhaust branches, and the exhaust trunk are sealed such that, within the battery pack interior, vent byproducts are contained by the module enclosure assemblies, the exhaust branches, and the exhaust trunk.

In some aspects, the techniques described herein relate to a method, wherein the battery module enclosure assembly is one of a plurality of battery module enclosure assemblies within the battery pack enclosure assembly.

In some aspects, the techniques described herein relate to a method, wherein each of the battery module enclosure assemblies includes at least one cell stack having a plurality of battery cells.

In some aspects, the techniques described herein relate to a method, wherein cells stacks each include a plurality of individual battery cells configured to vent into a liquid coolant.

In some aspects, the techniques described herein relate to a method, further including managing thermal energy within the battery pack interior using an immersion thermal management system.

In some aspects, the techniques described herein relate to a method, further including communicating a liquid coolant through a coolant inlet trunk into the battery pack interior, and communicating the liquid coolant through one of a plurality of coolant inlet branches from the coolant inlet trunk to one of the plurality of battery module enclosures.

In some aspects, the techniques described herein relate to a method, wherein the exhaust branch is one of a plurality of exhaust branches, each of the exhaust branches connecting one of the battery enclosure modules to the exhaust trunk, and further including communicating both the vent byproducts and the liquid coolant through one of the exhaust branches to the exhaust trunk.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a schematic view of a prior art battery pack.

FIG. 2 illustrates a side view of an electrified vehicle having a traction battery pack.

FIG. 3 illustrates a perspective and partially section view of a battery pack according to an exemplary aspect of the present disclosure.

FIG. 4 illustrates a schematic top view of the battery pack of FIG. 3.

FIG. 5 illustrates a schematic top view of a battery pack according to another exemplary aspect of the present disclosure.

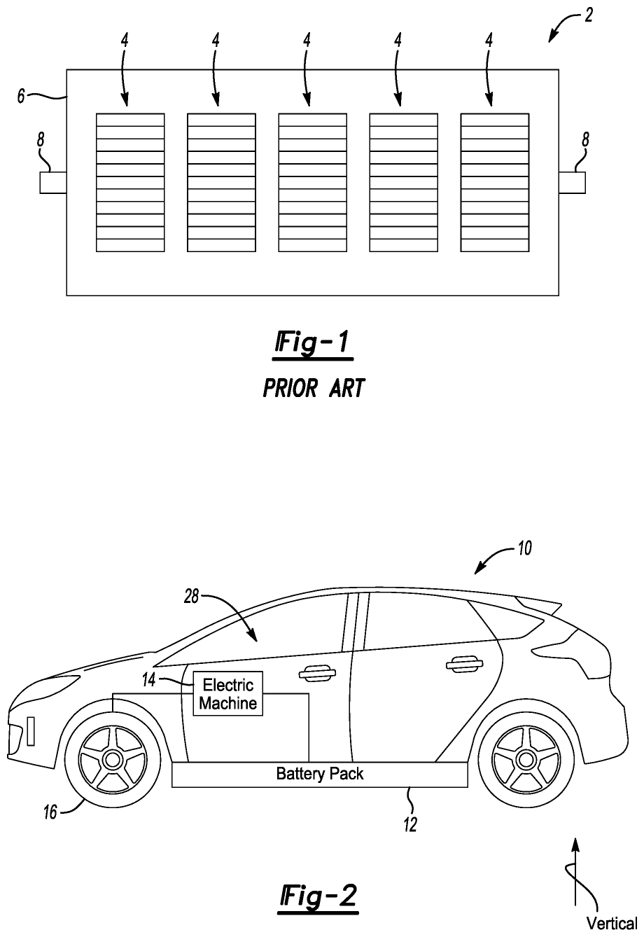

### DETAILED DESCRIPTION

This disclosure relates generally to a traction battery pack for an electrified vehicle and, in particular, to discharging vent byproducts from an interior of the traction battery pack.

With reference to FIG. 2, an electrified vehicle 10 includes a traction battery pack 12, an electric machine 14, and wheels 16. The battery pack 12 powers the electric machine 14, which can convert electric power to torque to drive the wheels 16. The battery pack 12 is a traction battery pack as the battery pack 12 is used for propulsion.

The battery pack 12 is, in the exemplary embodiment, secured to an underbody of the electrified vehicle 10. The battery pack 12 could be located elsewhere on the electrified vehicle 10 in other examples.

The example vehicle 10 is a battery electric vehicle (BEV). In another example, the vehicle 10 could be another type of electrified vehicle, such as a hybrid electric vehicle (HEV), plug-in hybrid electric vehicle (PHEV), or a conventional vehicle. A hybrid electric vehicle selectively drives wheels using torque provided by an internal combustion engine instead of, or in addition to, an electric machine. Generally, the electrified vehicle 10 could be any type of vehicle having a traction battery pack.

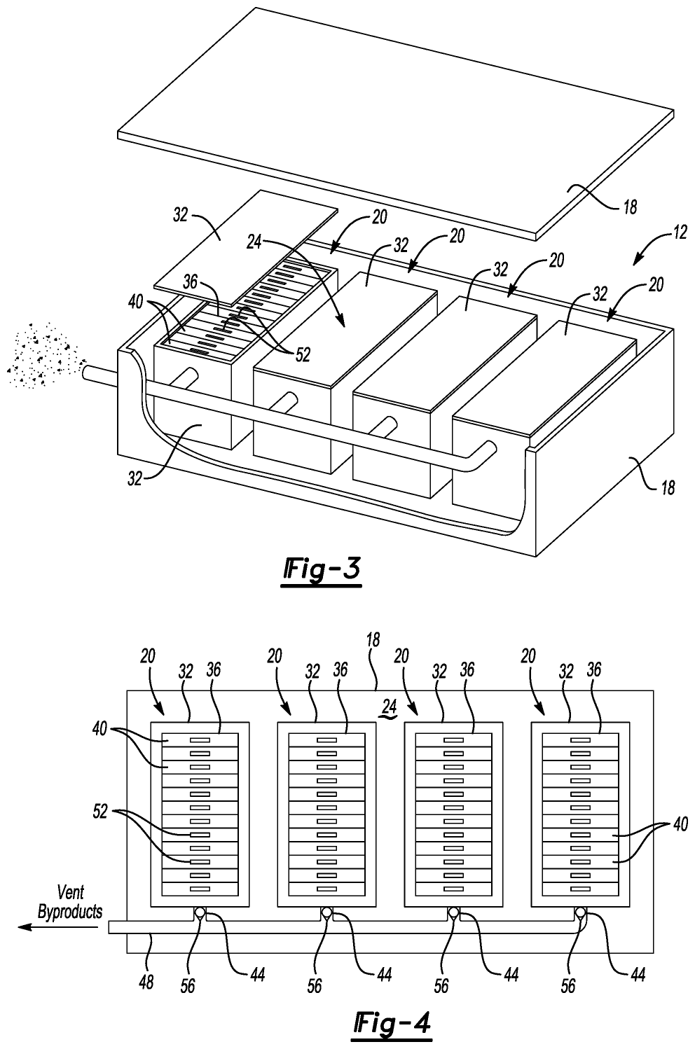

Referring now to FIGS. 3 and 4, the battery pack 12 includes a battery pack enclosure assembly 18 and a plurality of battery modules 20 that are housed within an interior 24 of the battery pack enclosure assembly 18. Each of the battery modules 20 includes a module enclosure assembly 32 and a cell stack 36 housed within the module enclosure assembly. The cell stack 36 includes a plurality of individual battery cells 40.

In this example, each of the module enclosure assemblies 32 houses a single cell stack 36. In other examples, the module enclosure assemblies 32 could hold more than one cell stack 36.

Also disposed within the interior 24 are a plurality of exhaust branches 44 and an exhaust trunk 48. One of the exhaust branches 44 connects to each one of the module enclosure assemblies 32 and the exhaust trunk 48. In other examples, two or more exhaust branches 44 could connect to each of the module enclosure assemblies 32. The module enclosure assemblies 32 are sealed such the exhaust branches 44 are the exclusive flow path from the module enclosure assemblies 32.

If vent byproducts are released from one or more of the battery cells 40. The vent byproducts can be released from the battery cells 40 through a vent 52. Pressure increases within one of the battery cells 40 can cause the vent 52 to rupture creating a path for the vent byproducts to be released from inside the battery cell 40.

After the vent byproducts pass through the vent 52, the vent byproducts are initially contained within an interior of the module enclosure assembly 32. The vent byproducts can then pass from the module enclosure assembly 32 through the exhaust branch 44 to move outside an interior of the module enclosure assembly 32. The exhaust branches 44, in this example, each extend from one of the module enclosure assemblies 32 to the exhaust trunk 48.

The exhaust branch 44 delivers the vent byproducts from the module enclosure assembly 32 to the exhaust trunk 48. The exhaust branches 44 open to the exhaust trunk 48 within the battery pack interior 24. The exhaust trunk 48 communicates the vent byproducts received from the exhaust branches 44 through the battery pack enclosure assembly 18 to an area outside the battery pack enclosure assembly 18.

Thus, vent byproducts are contained within the module enclosure assembly 32 having the one or more battery cells 40 that are venting, the exhaust branch 44 connected to that module enclosure assembly 32, and the exhaust trunk 48 until the vent byproducts are discharged or exhausted from the battery pack 12. The vent byproducts are not released into other areas within the interior 24 of the battery pack 12. This helps to mitigate a transfer of thermal energy to the battery modules 20 that are not venting.

Within the interior 24, the exhaust branches 44 are configured to deliver vent byproducts to the exhaust trunk 48. Each of the exhaust branches 44 can include a check valve 56 that blocks vent byproducts exhausted from one of the battery modules 20 from backflowing through exhaust branches 44 into the module enclosure assembly 32 of another battery module 20 that contains no battery cells 40 that are venting.

Introducing the vent byproducts to the exhaust trunk 48 within the battery pack enclosure assembly 18 can simplify exhausting the vent byproducts to the area outside the battery pack enclosure assembly 18. For example, only a single outlet through the battery pack enclosure assembly 18 rather than an outlet for each exhaust branch 44.

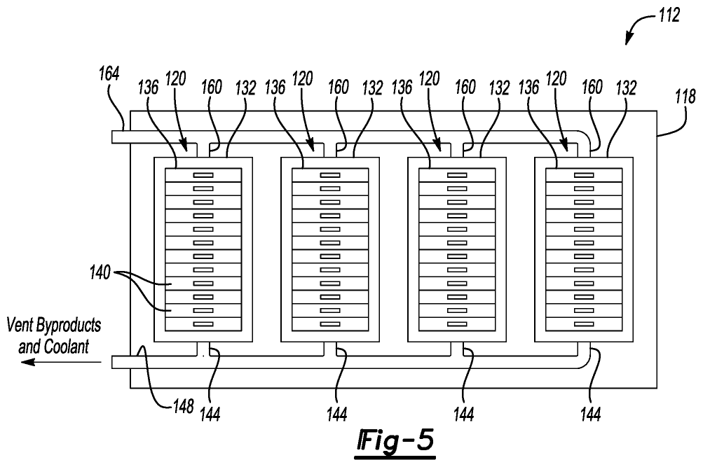

With reference now to FIG. 5, in a variation of the example disclosed above, a plurality of battery modules 120 are contained within a battery pack enclosure assembly 118 of a battery pack 112. Thermal energy within battery modules 120 is managed using an immersion thermal management system.

In this example, a plurality of coolant inlet branches 160 are configured to communicate a liquid coolant from a coolant inlet trunk 164 to a respective one of the battery modules 120. The liquid coolant can be used to manage thermal energy within the battery modules 120.

Should battery cells 140 of cell stacks 136 within the battery modules 120 begin to vent, the vent byproducts are expelled from the battery cell 140 that is venting directly into the coolant within the module enclosure assembly 132 of the battery module 120 having the battery cell 140 that is venting.

A mixture of vent byproducts and coolant can then be communicated through an associated exhaust branch 144 to an exhaust trunk 148. The exhaust trunk 148 discharged the mixture of vent byproducts and coolant to an area outside the battery pack enclosure assembly 118. Check valves (not shown in FIG. 5) could be used to block flow of vent byproducts from the exhaust branches 144 back into the module enclosure assemblies 132. Check valves could also be added to the coolant inlet branches 160, the coolant inlet trunk 164, or both. These check valves could block backflow of gas/particulates/fluid during cell venting, particularly during the initial pressure increase.

In the example of FIG. 5, the liquid coolant moves within the module enclosure assemblies 132 along a flow path that is parallel to an orientation of the battery cells 140 within the cell stacks 136. In other examples, the flow path could be oriented differently, such as perpendicular to a longitudinal axis of the cell stack.

Features of the disclosed examples include substantially sealing individual cell stacks within respective module enclosure assemblies that are disposed within a larger battery pack enclosure assembly. The individual module enclosure assemblies can contain vent byproducts from the cells within that module enclosure assembly and deliver those vent byproducts through exhaust branches and an exhaust trunk to an area outside a battery pack enclosure. As the cell stacks are contained within module enclosure assemblies, the vent byproducts are not free to move to positions adjacent other battery modules within the battery pack.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack venting assembly, comprising:
a battery pack enclosure assembly providing an battery pack interior;
a plurality of cell stacks within the battery pack interior, each cell stack including a plurality of battery cells;
a plurality of module enclosure assemblies within the battery pack interior, each of the module enclosure assemblies housing one or more of the cell stacks;
an exhaust trunk extending through the battery pack enclosure assembly from the battery pack interior to an area outside the battery pack interior; and
a plurality of exhaust branches within the battery pack interior, each of the exhaust branches extending from one of the module enclosure assemblies to the exhaust trunk.

2. The battery pack venting assembly of claim 1, wherein the exhaust branches each open to the exhaust trunk within the battery pack interior.

3. The battery pack venting assembly of claim 1, wherein the exhaust branches are each configured to communicate vent byproducts directly from one of the module enclosure assemblies to the exhaust trunk.

4. The battery pack venting assembly of claim 1, wherein the exhaust trunk is configured to communicate vent byproducts received from one or more of the exhaust branches to the area outside the battery pack enclosure assembly.

5. The battery pack venting assembly of claim 1, wherein the module enclosure assemblies, the exhaust branches, and the exhaust trunk are sealed such that, within the battery pack interior, vent byproducts are contained by the module enclosure assemblies, the exhaust branches, and the exhaust trunk.

6. The battery pack venting assembly of claim 1, wherein the cell stacks are immersion cooled.

7. The battery pack venting assembly of claim 1, further comprising a plurality of coolant inlet branches, each of the coolant inlet branches configured to communicate a liquid coolant to one of the module enclosure assemblies.

8. The battery pack venting assembly of claim 7, further comprising a coolant inlet trunk that communicates a liquid coolant to each of the plurality of coolant inlet branches.

9. The battery pack venting assembly of claim 8, wherein the coolant inlet branches are directly connected to the coolant inlet trunk within the battery pack interior.

10. The battery pack venting assembly of claim 1, wherein the plurality of exhaust branches are configured to communicate liquid coolant and vent byproducts directly from one of the module enclosure assemblies to the exhaust trunk.

11. The battery pack venting assembly of claim 1, wherein the battery cells are each configured to vent into a liquid coolant.

12. The battery pack venting assembly of claim 1, further comprising a plurality of check valves that block a backflow of vent byproducts from the exhaust trunk through the exhaust branches.

13. A method of venting from a battery pack, comprising:
within a battery pack interior provided by a battery pack enclosure assembly, communicating vent byproducts from a battery module enclosure assembly into an exhaust branch, the vent byproducts expelled from at least one battery cell within a cell stack that is housed within the battery pack interior;
within the battery pack interior, communicating the vent byproducts through the exhaust branch into an exhaust trunk; and
communicating the vent byproducts through the exhaust trunk through the battery pack enclosure to an area outside the battery pack enclosure to exhaust the vent byproducts from the battery pack enclosure.

14. The method of claim 13, wherein the module enclosure assemblies, the exhaust branches, and the exhaust trunk are sealed such that, within the battery pack interior, vent byproducts are contained by the module enclosure assemblies, the exhaust branches, and the exhaust trunk.

15. The method of claim 13, wherein the battery module enclosure assembly is one of a plurality of battery module enclosure assemblies within the battery pack enclosure assembly.

16. The method of claim 15, wherein each of the battery module enclosure assemblies includes at least one cell stack having a plurality of individual battery cells.

17. The method of claim 16, wherein cells stacks each include a plurality of battery cells configured to vent into a liquid coolant.

18. The method of claim 13, further comprising managing thermal energy within the battery pack interior using an immersion thermal management system.

19. The method of claim 15, further comprising communicating a liquid coolant through a coolant inlet trunk into the battery pack interior, and communicating the liquid coolant through one of a plurality of coolant inlet branches from the coolant inlet trunk to one of the plurality of battery module enclosures.

20. The method of claim 19, wherein the exhaust branch is one of a plurality of exhaust branches, each of the exhaust branches connecting one of the battery enclosure modules to the exhaust trunk, and further comprising communicating both the vent byproducts and the liquid coolant through one of the exhaust branches to the exhaust trunk.
